(19) United States
(12) Patent Application Publication
(10) Pub. No.: US 2026/0155453 A1
(43) Pub. Date: Jun. 4, 2026

(54) ALL-SOLID-STATE BATTERY

(71) Applicant: SAMSUNG ELECTRO-MECHANICS CO., LTD., Suwon-si, Gyeonggi-do (KR)

(72) Inventors: Junhyeon KIM, Suwon-si, Gyeonggi-do (KR); Han KIM, Suwon-si, Gyeonggi-do (KR); Kwangjik LEE, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/706,538

(22) PCT Filed: Apr. 9, 2024
(86) PCT No.: PCT/KR2024/004700

§ 371 Date: May 1, 2024

(30) Foreign Application Priority Data
Dec. 8, 2023 (KR) 10-2023-0177501

(51) Int. Cl. H01M 10/0585; H01M 10/0525

(52) U.S. Cl. CPC H01M 10/0585; H01M 10/0525

(57) ABSTRACT

An all-solid-state battery includes: a solid electrolyte layer; a first internal electrode layer and a second internal electrode layer opposite to each other with the solid electrolyte layer interposed therebetween; a first external electrode connected with the first internal electrode layer; a second external electrode connected with the second internal electrode layer; a first margin layer disposed between the first internal electrode layer and the second external electrode; and a second margin layer disposed between the second internal electrode layer and the first external electrode. An active region in which the first internal electrode layer and the second internal electrode layer overlap, the first margin layer, and the second margin layer satisfy 0.05≤(a+c)/b≤0.1, in which a is a length of the first margin layer, b is a length of the active region, and c is a length of the second margin layer.

### CROSS-REFERENCE TO REPLATED APPLICATION

This application claims priority to and the benefit of Korean Patent Application No. 10-2023-0177501 filed in the Korean Intellectual Property Office on Dec. 8, 2023, the entire contents of which are incorporated herein by reference.

### TECHNICAL FIELD

The present disclosure relates to an all-solid-state battery.

### BACKGROUND ART

As the use of portable electronic devices for long periods of time becomes more common, high capacity batteries are required, and the spread of wearable electronic devices requires the safety of batteries. Therefore, the development of all-solid-state batteries using solid electrolytes instead of liquid electrolytes is actively underway.

An all-solid-state battery is a battery that replaces the existing liquid electrolyte with a solid electrolyte, which greatly reduces the risk of explosion due to the flammability of the liquid electrolyte and enables stable operation even in harsh environments with relatively high temperature and high pressure because a liquid electrolyte is not used. It is also expected to be used in the future because it is possible to stack cells without a separate cooling part, which enables high energy density in the same volume.

### DISCLOSURE

The present disclosure attempts to provide an all-solid-state battery capable of securing sufficient capacity and energy density with a low short circuit rate.

However, the object to be solved in the embodiments of the present disclosure is not limited to the foregoing object, and may be variously extended in the scope of the technical spirit included in the present disclosure.

An embodiment of the present disclosure provides an all-solid-state battery including: a solid electrolyte layer; a first internal electrode layer and a second internal electrode layer opposite to each other with the solid electrolyte layer interposed therebetween; a first external electrode connected with the first internal electrode layer; a second external electrode connected with the second internal electrode layer; a first margin layer disposed between the first internal electrode layer and the second external electrode; and a second margin layer disposed between the second internal electrode layer and the first external electrode. An active region in which the first internal electrode layer and the second internal electrode layer overlap, the first margin layer, and the second margin layer satisfy 0.05≤(a+c)/b≤0.1, in which a is a length of the first margin layer, b is a length of the active region, and c is a length of the second margin layer.

Further, the length of the active region, the length of the first margin layer, and the length of the second margin layer may be lengths in a direction in which the first external electrode and the second external electrode face each other.

Further, each of the first internal electrode layer and the second internal electrode layer may be disposed in plurality, and the length of the active region may be a maximum value of lengths of overlapping portions of the plurality of the first internal electrode layers and the plurality of the second internal electrode layers.

Further, each of the first internal electrode layer and the second internal electrode layer may be disposed in plurality, and the length of the active region may be a minimum value of lengths of overlapping portions of the plurality of first internal electrode layers and the plurality of second internal electrode layers.

Further, each of the first internal electrode layer and the second internal electrode layer may be disposed in plurality, and the length of the active region may be an arithmetic average value of at least two lengths among lengths of at least two of overlapping portions of the plurality of the first internal electrode layers and the plurality of the second internal electrode layers.

Further, each of the first margin layer and the second margin layer may be disposed in plurality, the a may be a maximum value of lengths of the plurality of the first margin layers, and the c may be a maximum value of lengths of the plurality of the second margin layers.

Further, each of the first margin layer and the second margin layer may be disposed in plurality, the a may be a minimum value of lengths of the plurality of the first margin layers, and the c may be a minimum value of lengths of the plurality of the second margin layers.

Further, each of the first margin layer and the second margin layer may be disposed in plurality, the a may be an arithmetic average value of lengths of at least two of the plurality of the first margin layers, and the c may be an arithmetic average value of lengths of at least two of the plurality of the second margin layers.

Further, the first internal electrode layer may be electrically connected to the first external electrode, and electrically isolated from the second external electrode by the first margin layer, and the second internal electrode layer may be electrically connected to the second external electrode, and electrically isolated from the first external electrode by the second margin layer.

Further, the first and second margin layers may include an insulating material.

Further, the first and second margin layers may include a ceramic material.

Further, the ceramic material may include alumina (Al₂O₃), aluminum nitride (AlN), beryllium oxide (BeO), boron nitride (BN), silicon (Si), silicon carbide (SiC), silica (SiO₂), silicon nitride (Si₃N₄), gallium arsenide (GaAs), gallium nitride (GaN), barium titanate (BaTiO₃), zirconium dioxide (ZrO₂), or mixtures thereof.

Further, the first margin layer and the second margin layer may include a solid electrolyte included in the solid electrolyte layer.

According to at least one of the embodiments, a battery main body with an optimal margin ratio allows for securing sufficient capacity and energy density with a low short circuit rate.

### DESCRIPTION OF THE DRAWINGS

FIG. 1 is a perspective view schematically illustrating an all-solid-state battery according to an embodiment.

FIG. 2 is a perspective view schematically illustrating a battery main body of the all-solid-state battery illustrated in FIG. 1.

FIG. 3 is a cross-sectional view taken along lines III-III′ of FIG. 1.

FIG. 4 is a diagram illustrating the battery main body of FIG. 3 to illustrate an active region and a margin region.

FIG. 5 is a graph illustrating the relationship between a ratio of a margin region length to an active region length and a short circuit rate of the all-solid-state battery.

FIG. 6 is a graph illustrating the relationship between a ratio of a margin region length to an active region length and a capacity of the all-solid-state battery.

FIG. 7 is a graph illustrating the relationship between a ratio of a margin region length to an active region length and an energy density of the all-solid-state battery.

### MODE FOR INVENTION

Hereinafter, embodiments of the present disclosure will be described in detail with reference to the accompanying drawings so that those skilled in the art may easily implement the present disclosure. The drawings and description are to be regarded as illustrative in nature and not restrictive. Like reference numerals designate like elements throughout the specification. Further, some constituent elements in the drawing may be exaggerated, omitted, or schematically illustrated, and a size of each constituent element does not reflect the actual size entirely.

Further, the accompanying drawings are provided for helping to easily understand embodiments disclosed in the present specification, and the technical spirit disclosed in the present specification is not limited by the accompanying drawings, and it will be appreciated that the present disclosure includes all of the modifications, equivalent matters, and substitutes included in the spirit and the technical scope of the present disclosure.

Terms including an ordinary number, such as first and second, are used for describing various constituent elements, but the constituent elements are not limited by the terms. The terms are used only to discriminate one constituent element from another constituent element.

Further, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is “on” a reference portion, the element is located above or below the reference portion, and it does not necessarily mean that the element is located “above” or “on” in a direction opposite to gravity.

In the present application, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance. Therefore, unless explicitly described to the contrary, the word “comprise”, and variations such as “comprises” or “comprising”, will be understood to imply the inclusion of stated elements but not the exclusion of any other elements.

Further, in the entire specification, when it is referred to as “on a plane”, it means when a target part is viewed from above, and when it is referred to as “on a cross-section”, it means when the cross-section obtained by cutting a target part vertically is viewed from the side.

Further, throughout the specification, when it is referred to as “connected”, this does not only mean that two or more constituent elements are directly connected, but may mean that two or more constituent elements are indirectly connected through another constituent element, are physically connected, electrically connected, or are integrated even though two or more constituent elements are referred as different names depending on a location and a function.

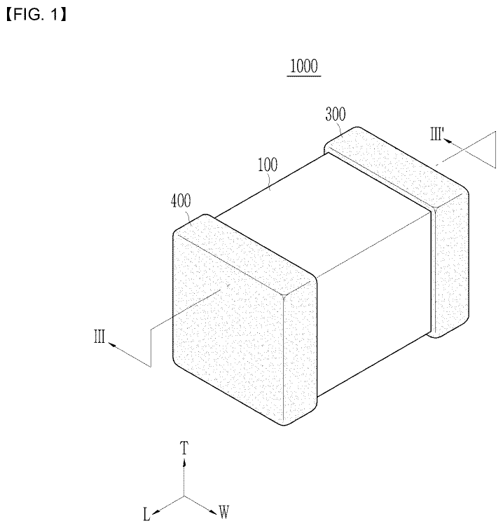

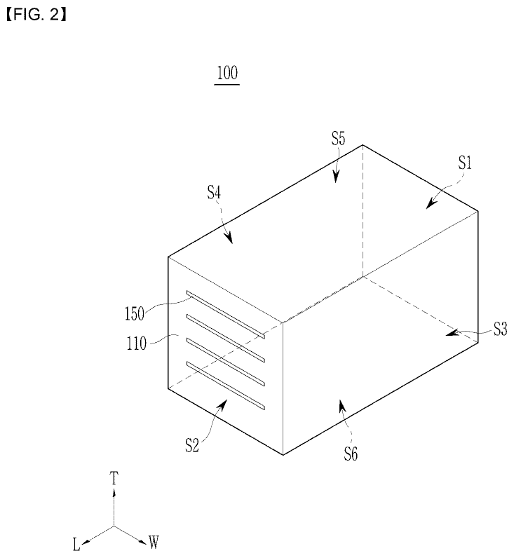

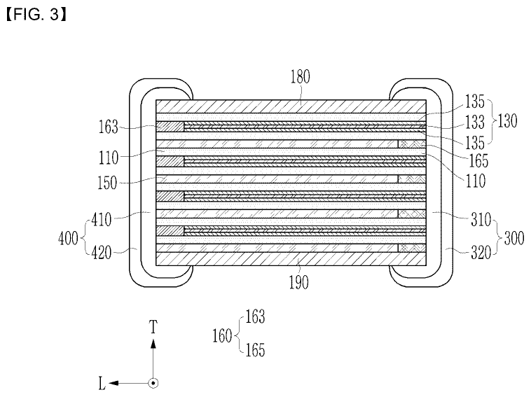

FIG. 1 is a perspective view schematically illustrating an all-solid-state battery according to an embodiment, FIG. 2 is a perspective view schematically illustrating a battery main body of the all-solid-state battery illustrated in FIG. 1, and FIG. 3 is a cross-sectional view taken along lines III-III′ of FIG. 1.

Referring to FIGS. 1, 2, and 3, an all-solid-state battery 1000 according to the present embodiment includes a battery main body 100, a first external electrode 300, and a second external electrode 400.

First, defining directions to clearly describe the present embodiment, the L-axis, W-axis, and T-axis shown in the drawings refer to axes representing the length direction, width direction, and thickness direction of the all-solid-state battery 1000, respectively.

The thickness direction (T-axis direction) may be perpendicular to the wide surface (principal plane) of a component with a sheet shape. For example, the thickness direction (T-axis direction) may be used interchangeably with the direction in which the components of the battery main body 100 are stacked.

The length direction (L-axis direction) is a direction parallel to the wide surface (principal plane) of the component having a sheet shape and may be intersecting (or orthogonal) to the thickness direction (T-axis direction). For example, the length direction (L-axis direction) may be a direction in which a first external electrode 300 and a second external electrode 400 face each other.

The width direction (W-axis direction) is a direction parallel to the wide surface (principal surface) of a component having a sheet shape and may be simultaneously intersecting (or orthogonal to) the thickness direction (T-axis direction) and the length direction (L-axis direction).

The battery main body 100 may have a roughly hexahedral shape, but the present embodiment is not limited thereto. Due to shrinkage during sintering, the battery main body 100 may have a substantially hexahedral shape, although not a completely hexahedral shape. For example, the battery main body 100 may have a roughly cuboidal shape, but may have a shape with rounded portions corresponding to corners or vertices.

In the present embodiment, for ease of description, the surfaces facing each other in the length direction (L-axis direction) are defined as a first surface S1 and a second surface S2, the surfaces facing each other in the width direction (W-axis direction) and connecting the first surface S1 and the second surface S2 are defined as a third surface S3 and a fourth surface S4, and the surfaces facing each other in the thickness direction (T-axis direction) and connecting the first surface S1 and the second surface S2 are defined as a fifth surface S5 and a sixth surface S6.

Therefore, the first direction, which is the direction in which the first surface S1 and the second surface S2 face each other, may be the length direction (L-axis direction), and the second direction and the third direction, which are perpendicular to the first direction and perpendicular to each other, may be the thickness direction (T-axis direction) and the width direction (W-axis direction), or the width direction (W-axis direction) and the thickness direction (T-axis direction), respectively.

The length of the battery main body 100 may mean, based on an optical microscope or scanning electron microscope (SEM) photograph of the length direction (L-axis direction)-thickness direction (T-axis direction) cross-section at a width direction (W-axis direction) central portion of the battery main body 100, a maximum value among the lengths of a plurality of line segments each connecting two outermost boundary lines opposite in the length direction (L-axis direction) of the battery main body 100, which is shown in the above-described cross-sectional photograph, and parallel to the length direction (L-axis direction). Hereinafter, the length direction (L-axis direction)-thickness direction (T-axis direction) cross-section means a cross-section where the length direction (L-axis direction) and the thickness direction (T-axis direction) intersect (or are perpendicular to) each other. On the other hand, the length of the battery main body 100 may mean a minimum value among the lengths of a plurality of line segments each connecting two outermost boundary lines opposite in the length direction (L-axis direction) of the battery main body 100, which is shown in the above-described cross-sectional photograph, and parallel to the length direction (L-axis direction). On the other hand, the length of the battery main body 100 may mean an arithmetic average value of the lengths of at least two line segments among a plurality of line segments each connecting the two outermost boundary lines opposite in the length direction (L-axis direction) of the battery main body 100, which is shown in the above-described cross-sectional photograph, and parallel to the length direction (L-axis direction).

The thickness of the battery main body 100 may mean, based on an optical microscope or SEM photograph of the length direction (L-axis direction)-thickness direction (T-axis direction) cross-section at a width direction (W-axis direction) central portion of the battery main body 100, a maximum value among the lengths of a plurality of line segments each connecting two outermost boundary lines opposite in the thickness direction (T-axis direction) of the battery main body 100, which is shown in the above-described cross-sectional photograph, and parallel to the thickness direction (T-axis direction). On the other hand, the thickness of the battery main body 100 may mean a minimum value among the lengths of a plurality of line segments each connecting two outermost boundary lines opposite in thickness direction (T-axis direction) of the battery main body 100, which is shown in the above-described cross-sectional photograph, and parallel to the thickness direction (T-axis direction). On the other hand, the thickness of the battery main body 100 may mean an arithmetic average value of the lengths of at least two line segments among a plurality of line segments each connecting the two outermost boundary lines opposite in the thickness direction (T-axis direction) of the battery main body 100, which is shown in the above-described cross-sectional photograph, and parallel to the thickness direction (T-axis direction).

The width of the battery main body 100 may mean, based on an optical microscope or SEM photograph of the width direction (W-axis direction) cross-section at a thickness direction (T-axis direction) central portion of the battery main body 100, a maximum value among the lengths of a plurality of line segments each connecting two outermost boundary lines opposite in the width direction (W-axis direction) of the battery main body 100, which is shown in the above-described cross-sectional photograph, and parallel to the width direction (W-axis direction). Hereinafter, the length direction (L-axis direction)-width direction (W-axis direction) cross-section means a cross-section where the length direction (L-axis direction) and the width direction (W-axis direction) intersect (or are perpendicular to) each other. On the other hand, the width of the battery main body 100 may mean a minimum value of the length of the plurality of line segments each connecting two outermost boundary lines opposite in the width direction (W-axis direction) of the battery main body 100, which is shown in the above-described cross-sectional photograph, and parallel to the width direction (W-axis direction). On the other hand, the width of the battery main body 100 may mean an arithmetic average value of the length of at least two line segments among a plurality of line segments each connecting the two outermost boundary lines opposite in the width direction (W-axis direction) of the battery main body 100, which is shown in the above-described cross-sectional photograph, and parallel to the width direction (W-axis direction).

The battery main body 100 may include a solid electrolyte layer 110, a positive electrode layer 130, a negative electrode layer 150, a margin layer 160, an upper protective layer 180, and a lower protective layer 190.

Each of the solid electrolyte layer 110, the positive electrode layer 130, and the negative electrode layer 150 may be a plurality. The positive electrode layer 130 and the negative electrode layer 150 may be alternately stacked in the thickness direction (T-axis direction) with the solid electrolyte layer 110 interposed therebetween. For example, in the thickness direction (T-axis direction), the negative electrode layer 150, the solid electrolyte layer 110, the positive electrode layer 130, and then the solid electrolyte layer 110 may be stacked in sequence again. That is, the positive electrode layer 130 and the negative electrode layer 150 may face each other with the solid electrolyte layer 110 interposed therebetween. The positive electrode layer 130 and the negative electrode layer 150 may be defined as a first internal electrode layer and a second internal electrode layer, or a second internal electrode layer and a first internal electrode layer.

Based on the solid electrolyte layer 110, the positive electrode layer 130 may be disposed on one side of the solid electrolyte layer 110 and the negative electrode layer 150 may be disposed on the other side of the solid electrolyte layer 110.

The solid electrolyte layer 110 includes a solid electrolyte. The solid electrolyte may act as a passage for lithium (Li) ions. The solid electrolyte included in the solid electrolyte layer 110 may include a glass-ceramic based electrolyte including lithium halogen (LiX, X=F, a halogen element, such as Br, CI, and I). A glass-ceramic (or crystallized glass) is a mixture of amorphous and crystalline materials, and a glass-ceramic based electrolyte may be an electrolyte that has undergone some crystallization through sintering, resulting in a mixture of amorphous and crystalline materials. For example, peaks and halos observed in X-ray diffraction or electron diffraction may indicate a mixture of amorphous and crystalline materials.

The glass-ceramic based electrolyte may contain a mixture of an amorphous material and two or more types of crystalline materials. Further, the crystalline material included in the glass-ceramic based electrolyte may include a lithium compound crystalline phase including lithium.

When the solid electrolyte layer 110 includes the glass-ceramic based electrolyte, the solid electrolyte layer 110 is sufficiently densified after sintering to achieve high ionic conductivity.

The glass-ceramic based electrolyte may include lithium (Li) oxide, boron (B) oxide, silicon (Si) oxide, aluminum (Al) oxide, gallium (Ga) oxide, phosphorus (P) oxide, germanium (Ge) oxide, magnesium (Mg) oxide, and lithium chloride (LiCl). In one example, the glass-ceramic based electrolyte may include Li₂O—B₂O₃—SiO₂—P₂O₅—GeO₂—LiCl.

Additionally, the solid electrolyte included in the solid electrolyte layer 110 may include a Lithium Borosilicate-based electrolyte (hereinafter referred to as an LBSO-based electrolyte). The above LBSO-based electrolyte is a glassy electrolyte, and means that the LBSO-based electrolyte is amorphous, and halos may be observed in X-ray diffraction or electron diffraction. When the solid electrolyte layer 110 includes the LBSO-based electrolyte, an amorphous state may be maintained during sintering while lowering the sintering temperature. Thereby, high ionic conductivity may be implemented, and the advantage that reactivity between the solid electrolyte layer 110 and the electrode is not large may be secured. The LBSO-based electrolyte may include lithium (Li), boron (B), silicon (Si), aluminum (AI), phosphorus (P), germanium (Ge), and sulfur(S).

Further, the solid electrolyte included in the solid electrolyte layer 110 may be one or more selected from the group consisting of a Garnet-type, a Nasicon-type, a NISICON-type, a perovskite-type, and a LiPON-type.

The garnet-based solid electrolyte may refer to lithium lanthanum zirconium oxide (LLZO), represented by LiₐLa_{b}Zr_{c}O₁₂, such as Li₇La₃Zr₂O₁₂, and the Nasicon-type solid electrolyte may refer to Li₁₊ₓAlₓM₂₋ₓ(PO₄)₃(LAMP) (0<x<2, M=Zr), lithium-aluminum-titanium-phosphate (LATP) of Li₁₊ₓAlₓGe₂₋ₓ(PO₄)₃ (0<x<1) in which Ti is introduced to Ti, Ge-type compounds (0<x<2, M=Zr), lithium-aluminum-germanium-phosphate (LAGP), represented by Li₁₊ₓAlₓGe₂₋ₓ(PO₄)₃ (0<x<1), such as Li_{1.3}Al_{0.3}Ge_{1.7}(PO₄)₃, with an excess of lithium introduced, and/or lithium-zirconium-phosphate (LZP), represented by LiZr₂(PO₄)₃.

In addition, the NISICON-type solid electrolyte may refer to solid solution oxide represented by xLi₃AO₄-(1-x)Li₄BO₄ (A: P, As, V, and the like, B: Si, Ge, Ti, and the like) and including Li₄Zn(GeO₄)₄, Li₁₀GeP₂O₁₂(LGPO), Li_{3.5}Si_{0.5}P_{0.5}O₄, Li_{10.42}Si(Ge)_{1.5}P_{1.5}Cl_{0.08}O_{11.92}, and the like, and solid solution sulfide represented by Li₄₋ₓM_{1-y}M′_{y}S₄ (M=Si, Ge and M′=P, Al, Zn, Ga) and including Li₂S—P₂S₅, Li₂S—SiS₂, Li₂S—SiS₂—P₂S₅, Li₂S—GeS₂, and the like.

Further, the perovskite-type solid electrolyte may refer to lithium lanthanum titanium oxide (LLTO), represented by Li₃ₓLa_{2/3-x□1/3-2x}TiO₃ (0<x<0.16, vacancy), such as Li_{1/8}La_{5/8}TiO₃, and the LiPON-type solid electrolyte may mean a nitride, such as lithium phosphorous oxynitride, such as Li_{2.8}PO_{3.3}N_{0.46}.

The positive electrode layer 130 may be exposed to the first surface S1 of the battery main body 100, and may be connected to the first external electrode 300. The positive electrode layer 130 may include a positive electrode current collector 133 and a positive electrode active material layer 135.

The positive electrode current collector 133 may, in one example, be made of a plate-like member or a thin member. In another example, the positive electrode current collector 133 may be a porous body shaped like net, mesh, or the like.

The positive electrode current collector 133 may be a porous metal plate made of, for example, stainless steel, nickel (Ni), copper (Cu), tin (Sn), aluminum (Al), or an alloy thereof, but is not limited theretos. The positive electrode current collector 133 may also be coated with an oxidation-resistant metal or alloy film to prevent oxidation.

Alternatively, the positive electrode current collector 133 may be made of a carbon-based plate, thin, linear, or circular member. The positive electrode current collector 133 may be made of a conductive carbon material, and the conductive carbon material may be graphite, a conductive fiber, such as carbon nanotube (CNT) or vapor grown carbon fiber (VGCF), or a conductive carbon, such as carbon black.

The positive electrode current collector 133 may also include one or more solid electrolytes.

The positive electrode active material layer 135 may include a positive electrode active material and be disposed on a surface of the positive electrode current collector 133. The positive electrode active material layer 135 may be formed by printing the positive electrode active material onto one or both surfaces of the positive electrode current collector 133, but the method of forming the positive electrode active material layer 135 is not limited thereto.

The positive electrode active material included in the positive electrode active material layer 135 may include a material including lithium (Li) ions. The positive electrode active material may reversibly intercalate or deintercalate lithium ions. That is, the positive electrode active material may include lithium ions and then serve to provide lithium ions to the negative electrode when charging the all-solid-state battery. The positive electrode active material may affect the capacity and output of the all-solid-state battery.

The positive electrode active material may include, for example, a compound represented by the following chemical formula: LiₐA_{l-b}M_{b}D₂ (in the formula, 0.90≤a≤1.8, 0≤b≤0.5); LiₐE_{l-b}M_{b}O_{2-c}D_{c} (in the formula, 0.90≤a≤1.8, 0≤b≤0.5, 0≤c≤0.05); LiE_{2-b}M_{b}O_{4-c}D_{c} (in the formula, 0≤b≤0.5, 0≤c≤0.05); LiₐNi_{1-b-c}Co_{b}M_{c}D_{α} (in the formula, 0.90≤a≤1.8, 0≤b≤0.5, 0≤c≤0.05, 0<α≤2); LiₐNi_{1-b-c}Co_{b}M_{c}O_{2-α}X_{α} (in the formula, 0.90≤a≤1.8, 0≤b≤0.5, 0≤c≤0.05, 0<α<2); LiₐNi_{1-b-c}Co_{b}M_{c}O_{2-α}X₂ (in the formula, 0.90≤a≤1.8, 0≤b≤0.5, 0≤c≤0.05, 0<α<2); LiₐNi_{1-b-c}Mn_{b}M_{c}D_{α} (in the formula, 0.90≤a≤1.8, 0≤b≤0.5, 0≤c≤0.05, 0<α≤2); LiₐNi_{1-b-c}Mn_{b}M_{c}O_{2-α}X_{α} (in the formula, 0.90≤a≤1.8, 0≤b≤0.5, 0≤c≤0.05, 0<α<2); LiₐNi_{1-b-c}Mn_{b}M_{c}O_{2-α}X₂ (in the formula, 0.90≤a≤1.8, 0≤b≤0.5, 0≤c≤0.05, 0<α<2); LiₐNi_{b}E_{c}G_{d}O₂ (in the formula, 0.90≤a≤1.8, 0≤b≤0.9, 0≤c≤0.5, 0.001≤d≤0.1); LiₐNi_{b}Co_{c}Mn_{d}GₑO₂ (in the formula, 0.90≤a≤1.8, 0≤b≤0.9, 0≤c≤0.5, 0≤d≤0.5, 0.001≤e≤0.1); LiₐNiG_{b}O₂ (in the formula, 0.90≤a≤1.8, 0.001≤b≤0.1); LiₐCoG_{b}O₂ (in the formula, 0.90≤a≤1.8, 0.001≤b≤0.1); LiₐMnG_{b}O₂ (in the formula, 0.90≤a≤1.8, 0.001≤b≤0.1); LiₐMn₂G_{b}O₄ (in the formula, 0.90≤a≤1.8, 0.001≤b≤0.1); QO₂; QS₂; LiQS₂; V₂O₅; LiV₂O₂; LiRO₂; LiNiVO₄; Li_{(3-f)}J₂PO₄₃ (0≤f≤2); Li_{(3-f)}Fe₂PO₄₃ (in the formula, 0≤f≤2); and LiFePO₄, and in the formula, A is Ni, Co, or Mn; M is Al, Ni, Co, Mn, Cr, Fe, Mg, Sr, V, or rare-earth element; D is O, F, S, or P; E is Co or Mn; X is F, S, or P; G is Al, Cr, Mn, Fe, Mg, La, Ce, Sr, or V; Q is Ti, Mo or Mn; R is Cr, V, Fe, Sc, or Y; J is V, Cr, Mn, Co, Ni, or Cu.

The positive electrode active material may also include LiCoO₂, LiMnₓO₂ₓ (in the formula, x=1 or 2), LiNi₁₋ₓMnₓO₂ₓ (in the formula, 0<x<1), LiNi_{1-x-y}CoₓMn_{y}O₂ (in the formula, 0≤x≤0.5, 0≤y≤0.5), LiFePO₄, TiS₂, FeS₂, TiS₃, or FeS₃, but is not limited thereto.

The positive electrode active material may optionally include a conductive material and a binder. However, the organic material, such as a binder, may not remain in the positive electrode active material layer 135 of the obtained positive electrode current collector 133 because the organic material is decomposed during sintering.

The conductive material is not particularly limited as long as the conductive material is conductive without causing chemical changes in the all-solid-state battery. For example, graphite, such as natural or artificial graphite; carbon-based materials, such as carbon black, acetylene black, ketchen black, channel black, furnace black, lamp black, and thermal black; conductive fibers, such as carbon fibers or metal fibers; carbon fluoride; metal components, such as lithium (Li), tin (Sn), aluminum (Al), nickel (Ni), copper (Cu), and oxides, nitrides, or fluorides thereof; conductive whiskers, such as zinc oxide, potassium titanate; conductive metal oxides, such as titanium oxide; conductive materials, such as polyphenylene derivatives, or the like.

The binder may be used to improve the binding of the active material to a conductive material or the like. The binder may include polyvinylidene fluoride, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, ethylene-propylene-diene terpolymer (EPDM), sulfonated EPDM, styrene butadiene rubber, fluorinated rubber, and various copolymers, but is not limited thereto.

In the meantime, the positive electrode layer 130 may further include a solid electrolyte component. The solid electrolyte component may include one or more of the aforementioned components, and may function as an ionic conduction channel within the positive electrode layer 130. This may reduce interfacial resistance.

The negative electrode layer 150 may be exposed to the second surface S2 of the battery main body 100, and may be connected to the second external electrode 400. The negative electrode layer 150 may include a negative electrode active material layer, and the negative electrode layer 150 may be formed solely of a negative electrode active material layer.

The negative electrode active material included in the negative electrode active material layer may store and release lithium ions that have migrated from the positive electrode during discharge of the all-solid-state battery to generate electrical energy. The negative electrode active material may include a carbon-based material, silicon, silicon oxide, silicon-based alloy, silicon-carbon-based material composite, tin, tin-based alloy, tin-carbon composite, metal oxide, or a combination thereof, and may include lithium metal and/or lithium metal alloy.

The lithium metal alloy may include lithium (Li), and a metal/quasi-metal alloyable with lithium. For example, the metal/quasi-metal alloyable with lithium may include Si, Sn, Al, Ge, Pb, Bi, Sb, Si—Y alloys (wherein Y is an alkali metal, an alkaline earth metal, a 13- to 16-group element, a transition metal, a rare earth element, or a combination thereof, and does not include Si), Sn—Y alloys (wherein Y is an alkali metal, an alkaline earth metal, a 13- to 16-group element, a transition metal, a transition metal oxide, such as lithium titanium oxide (Li₄Ti₅O₁₂), a rare earth element, or a combination element thereof, and does not include Sn), and MnOₓ (0<x≤2).

The element Y may be Mg, Ca, Sr, Ba, Ra, Sc, Y, Ti, Zr, Hf, Rf, V, Nb, Ta, Db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, Sn, In, TI, Ge, P, As, Sb, Bi, S, Se, Te, Po, or a combination thereof.

Furthermore, the oxide of the metal/quasi-metal alloyable with lithium may include lithium titanate oxide, vanadium oxide, lithium vanadium oxide, SnO₂, SiOₓ (0<x≤2), and the like. For example, the negative electrode active material may include one or more elements selected from elements among Group 13 to Group 16 of the periodic table of elements. For example, the negative electrode active material may include one or more elements selected from the group consisting of Si, Ge, and Sn.

The carbon-based material may include crystalline carbon, amorphous carbon, or a mixture thereof. The crystalline carbon may include graphite, such as natural or artificial graphite, which may be amorphous, plate-like, flake-like, spherical, or fibrous. The amorphous carbon may also include soft carbon (low temperature sintered carbon) or hard carbon, mesophase pitch carbides, sintered coke, graphene, carbon black, fullerene soot, carbon nanotubes, and carbon fibers, but is not limited to.

The silicon may be selected from the group consisting of Si, SiOₓ (0<x<2, for example, 0.5 to 1.5), Sn, SnO₂, or silicon-containing metal alloys, and mixtures thereof. The silicon-containing metal alloy may include, for example, one or more of silicon, Al, Sn, Ag, Fe, Bi, Mg, Zn, In, Ge, Pb, and Ti.

The negative electrode active material may optionally include a conductive material and a binder.

Conductive materials are not particularly limited, as long as they are conductive without causing chemical changes in the all-solid-state battery.

For example, graphite, such as natural or artificial graphite; carbon black, acetylene black, ketchen black, channel black, furnace black, carbon fluoride; metal components, such as lithium (Li), tin (Sn), aluminum (Al), nickel (Ni), copper (Cu), and oxides, nitrides, or fluorides thereof; conductive whiskers, such as zinc oxide and potassium titanate; conductive metal oxides, such as titanium oxide; and conductive materials, such as polyphenylene derivatives, may be used.

The binder may be used to improve the bonding of the active material to the conductive material or the like. The binder may include polyvinylidene fluoride, polyvinyl alcohol, carboxymethyl cellulose (CMC), starch, hydroxypropyl cellulose, regenerated cellulose, polyvinylpyrrolidone, polytetrafluoroethylene, polyethylene, polypropylene, ethylene-propylene-diene terpolymer (EPDM), sulfonated EPDM, styrene butadiene rubber, fluorinated rubber, and various copolymers, but is not limited thereto.

The margin layer 160 includes a positive electrode margin layer 163 and a negative electrode margin layer 165. The positive electrode margin layer 163 and the negative electrode margin layer 165 may be defined as a first margin layer and a second margin layer, or a second margin layer and a first margin layer. The positive electrode margin layer 163 may be disposed between the positive electrode layer 130 and the second external electrode 400 in the length direction (L-axis direction). The negative electrode margin layer 165 may be disposed between the negative electrode layer 150 and the first external electrode 300 in the length direction (L-axis direction). That is, the positive electrode margin layer 163 may extend along the length direction (L-axis direction) from the positive electrode layer 130 to form a portion of the second surface S2 of the battery main body 100, and the negative electrode margin layer 165 may extend along the length direction (L-axis direction) from the negative electrode layer 150 to form a portion of the first surface S1. One end of the positive electrode layer 130 may be electrically connected to the first external electrode 300. The other end of the positive electrode layer 130 may be connected to the positive electrode margin layer 163. The positive electrode layer 130 may be electrically isolated from the second external electrode 400 by the positive electrode margin layer 163. One end of the negative electrode layer 150 may be electrically connected to the second external electrode 400. The other end of the negative electrode layer 150 may be connected to the negative electrode margin layer 165. The negative electrode layer 150 may be electrically isolated from the first external electrode 300 by the negative electrode margin layer 165.

The margin layer 160 may be made of an insulating material, that is, a material that is not electronically (ionically) conductive.

The margin layer 160 may include ceramic materials, such as alumina (Al₂O₃), aluminum nitride (AlN), beryllium oxide (BeO), boron nitride (BN), silicon (Si), silicon carbide (SiC), silica (SiO₂), silicon nitride (Si₃N₄), gallium arsenide (GaAs), gallium nitride (GaN), barium titanate (BaTiO₃), zirconium dioxide (ZrO₂), mixtures thereof, oxides and/or nitrides of these materials, or any other suitable ceramic material, but is not limited thereto.

Meanwhile, the margin layer 160 may optionally include the solid electrolyte described above, and may include one or more of solid electrolyte, but is not limited to.

In addition, in the margin layer 160, a material having low ionic conductivity and electronic conductivity, that is, an insulating material, may be present or a material having a ionic conductivity (or electronic conductivity) similar to the ionic conductivity (or electronic conductivity) of the solid electrolyte may be present. For example, if a material having an ionic conductivity (or electronic conductivity) similar to the ionic conductivity (or electronic conductivity) of the solid electrolyte is present in the margin layer 160, the material may be the same material as the solid electrolyte in other areas, or it may be a different material. As another example, a material having ionic conductivity (or electronic conductivity) similar to the ionic conductivity (or electronic conductivity) of the solid electrolyte and an insulating material may be present together in the margin layer 160.

The upper protective layer 180 and the lower protective layer 190 may be an insulating layer made of an insulating material, that is, a material that is not electronically conductive (or ionically conductive).

The upper protective layer 180 and the lower protective layer 190 may include ceramic materials, such as alumina (Al₂O₃), aluminum nitride (AlN), beryllium oxide (BeO), boron nitride (BN), silicon (Si), silicon carbide (SiC), silica (SiO₂), silicon nitride (Si₃N₄), gallium arsenide (GaAs), gallium nitride (GaN), barium titanate (BaTiO₃), zirconium dioxide (ZrO₂), mixtures thereof, oxides and/or nitrides of these materials, or any other suitable ceramic material, but are not limited thereto. Further, the upper protective layer 180 and the lower protective layer 190 may optionally include any of the solid electrolytes described above, and may include one or more solid electrolytes, but are not limited to.

The first external electrode 300 and the second external electrode 400 are provided on the outside of the battery main body 100.

The first external electrode 300 is connected to the positive electrode layer 130 on the first surface S1 of the battery main body 100, and the second external electrode 400 is connected to the negative electrode layer 150 on the second surface S2 of the battery main body 100. The first external electrode 300 may be connected to the positive electrode layer 130 while covering the first surface S1 of the battery main body 100, and the second external electrode 400 may be connected to the negative electrode layer 150 while covering the second surface S2 of the battery main body 100.

In one example, the first eternal electrode 300 may extend from the first surface S1 to the third surface S3, the fourth surface S4, the fifth surface S5, and the sixth surface S6 of the battery main body 100 to partially cover each of the surfaces. Further, the second external electrode 400 may extend from the second surface S2 to the third surface S3, the fourth surface S4, the fifth surface S5, and the sixth surface S6 of the battery main body 100 to partially cover each of the surfaces.

In another example, the first external electrode 300 may extend from the first surface S1 to any one of the fifth surface S5 and the sixth surface S6 to partially cover the corresponding surface, and the second external electrode 400 may extend from the second surface S2 to any one of the fifth surface S5 and the sixth surface S6 to partially cover the corresponding surface.

The first external electrode 300 may include a first electrode layer 310 and a first plating layer 320, and the second external electrode 400 may include a second electrode layer 410 and a second plating layer 420.

The first electrode layer 310 of the first external electrode 300 may be electrically connected to the positive electrode layer 130, and the second electrode layer 410 of the second external electrode 400 may be electrically connected to the negative electrode layer 150.

In one example, the first electrode layer 310 of the first external electrode 300 and the second electrode layer 410 of the second external electrode 400 may be a plastic electrode including a conductive metal and glass, or a resin-based electrode including a conductive metal and resin.

The first electrode layer 310 of the first external electrode 300 and the second electrode layer 410 of the second external electrode 400 may be formed, for example, by applying a paste for terminal electrode including a conductive metal to each of the first surface S1 and the second surface S2 of the battery main body 100. In another example, the first electrode layer 310 of the first external electrode 300 and the second electrode layer 410 of the second external electrode 400 may be formed by transferring a dry film obtained by drying a conductive paste to the battery main body 100 and then sintering the dry film. However, the method of forming the first electrode layer 310 of the first external electrode 300 and the second electrode layer 410 of the second external electrode 400 is not limited thereto. The conductive metal may include, for example, one or more of, but not limited to, copper (Cu), nickel (Ni), tin (Sn), palladium (Pd), platinum (Pt), gold (Au), silver (Ag), tungsten (W), titanium (Ti), lead (Pb), and alloys thereof.

The first plating layer 320 of the first external electrode 300 covers the first electrode layer 310, and the second plating layer 420 of the second external electrode 400 covers the second electrode layer 410. The first and second plating layers 320 and 420 may serve to improve the mounting characteristics of the external electrodes. The first and second plating layers 320 and 420 may include one or more selected from the group consisting of copper (Cu), nickel (Ni), tin (Sn), palladium (Pd), platinum (Pt), gold (Au), silver (Ag), tungsten (W), titanium (Ti), lead (Pb), and alloys thereof, but are not limited to. The first and second plating layers 320 and 420 may be formed in one or more layers.

FIG. 4 is a diagram illustrating the battery main body of FIG. 3 to illustrate the active region and the margin region.

Referring to FIG. 4, the battery main body 100 includes an active region 210 and a margin region 230.

The active region 210 may be defined as a portion where the positive electrode layer 130 and the negative electrode layer 150 overlap in the thickness direction (T-axis direction). Further, the margin region may be defined as a portion of the battery main body 100 where the positive electrode layer 130 and the negative electrode layer 150 do not overlap in the thickness direction (T-axis direction).

The margin region 230 includes a first margin region 233 and a second margin region 235. The first margin region 233 is disposed between the active region 210 and the second external electrode 400, and the second margin region 235 is disposed between the active region 210 and the first external electrode 300. The first margin region 233 includes a portion where the positive electrode margin layer 163 is stacked in the thickness direction (T-axis direction), and the second margin region 235 includes a portion where the negative electrode margin layer 165 is stacked in the thickness direction (T-axis direction). That is, the first margin region 233 includes a portion where the positive electrode margin layer 163 is disposed, and the second margin region 235 includes a portion where the negative electrode margin layer 165 is disposed. The margin region 230 may be disposed on the outer portion in the battery main body 100 to prevent moisture infiltration, and may serve to prevent damage due to physical and chemical impact.

Hereinafter, the relationship between a length of the active region b and a length of the margin region a+c will be described with reference to FIG. 4. The length of the active region b is a length of the active region 210 in the length direction (L-axis direction). The length of the margin region a+c may be defined as the sum of a length a of the first margin region 233 and a length c of the second margin region 235 in the length direction (L-axis direction).

The length of the active region b may mean, for example, based on an optical microscope or SEM photograph of the length direction (L-axis direction)-thickness direction (T-axis direction) cross-section at a width direction (W-axis direction) central portion of the battery main body 100, a maximum value among the lengths of a plurality of line segments each connecting two outermost boundary lines opposite in the length direction (L-axis direction) of the active region 210, which is shown in the above-described cross-sectional photograph, and parallel to the length direction (L-axis direction). In other words, the length of the active region b may mean a maximum value among the lengths, in the length direction (L-axis direction), of the portion where the positive electrode layer 130 and the negative electrode layer 150, each disposed in plurality, overlap in the thickness direction (T-axis direction). In another example, the length b of the active region may mean a minimum value among the lengths of a plurality of line segments each connecting two outermost boundary lines opposite in the length direction (L-axis direction) of the active region 210, which is shown in the above-described cross-sectional photograph, and parallel to the length direction (L-axis direction). In other words, the length of the active region b may mean a minimum value among lengths in the length direction (L-axis direction), of the portion where the positive electrode layer 130 and the negative electrode layer 150, each disposed in plurality, overlap in the thickness direction (T-axis direction). In another example, the length of the active region b may mean an arithmetic average value of the lengths of at least two line segments among a plurality of line segments each connecting the two outermost boundary lines opposite in the length direction (L-axis direction) of the active region 210, which is shown in the above-described cross-sectional photograph, and parallel to the length direction (L-axis direction). In other words, the length of the active region b may mean an arithmetic average value of at least two lengths among the lengths in the length direction (L-axis direction) with respect to the portion where the positive electrode layer 130 and the negative electrode layer 150, each disposed in a plurality, overlap in the thickness direction (T-axis direction).

The length of the first margin region a may mean, for example, a maximum value among the lengths of a plurality of line segments each connecting two outermost boundary lines opposite in the length direction (L-axis direction) of the first margin region 233, which is shown in the above-described cross-sectional photograph, and parallel to the length direction (L-axis direction). In another example, the length of the first margin region a may mean a minimum value of the lengths among the lengths of a plurality of line segments each connecting two outermost boundary lines opposite in the length direction (L-axis direction) of the first margin region 233, which is shown in the above-described cross-sectional photograph, and parallel to the length direction (L-axis direction). In another example, the length of the first margin region a may mean an arithmetic average value of the lengths of at least two line segments among a plurality of line segments each connecting the two outermost boundary lines opposite in the length direction (L-axis direction) of the first margin region 233, which is shown in the above-described cross-sectional photograph, and parallel to the length direction (L-axis direction).

The length a of the first margin region may mean a length of any one of the positive electrode margin layers 163 which are disposed in plurality within the first margin region 233. Further, the length a of the first margin region may mean a representative value among lengths of the positive electrode layers 163 which are disposed in plurality within the first margin region 233. In one example, the length a of the first margin region may mean a maximum value among the lengths, in the length direction (L-axis direction), of the positive electrode layers 163 which are disposed in plurality within the first margin region 233. In another example, the length a of the first margin region may mean a minimum value among lengths, in the length direction (L-axis direction), of the positive electrode layers 163 which are disposed in plurality within the first margin region 233. In yet another example, the length a of the first margin region may mean an arithmetic average value of lengths, in the length direction (L-axis direction), of at least two positive electrode layer 163 among the positive electrode layers 163 which are disposed in plurality within the first margin region 233.

The length c of the second margin region may mean, for example, a maximum value among lengths of a plurality of line segments each connecting two outermost boundary lines opposite in the length direction (L-axis direction) of the second margin region 235, which is shown in the above-described cross-sectional photograph, and parallel to the length direction (L-axis direction). In another example, the length c of the second margin region may mean a minimum value among the lengths of a plurality of line segments each connecting two outermost boundary lines opposite in the length direction (L-axis direction) of the second margin region 235, which is shown in the above-described cross-sectional photograph, and parallel to the length direction (L-axis direction). In still another example, the length c of the second margin region may mean an arithmetic average value of the lengths of at least two line segments among a plurality of line segments each connecting the two outermost boundary lines opposite in the length direction (L-axis direction) of the second margin region 235, which is shown in the above-described cross-sectional photograph, and parallel to the length direction (L-axis direction).

The length c of the second margin region may mean a length of any one of the negative electrode margin layers 165 which are disposed in plurality within the second margin region 235. Further, the length c of the second margin region may mean a representative value among the lengths of the negative electrode layers 165 which are disposed in plurality within the second margin region 235. In one example, the length c of the second margin region may mean a maximum value among lengths, in the length direction (L-axis direction), of the negative electrode layers 165 which are disposed in plurality within the second margin region 235. In another example, the length c of the second margin region may mean a minimum value among lengths, in the length direction (L-axis direction), of the negative electrode layers 165 which are disposed in plurality within the second margin region 235. In still another example, the length c of the second margin region may mean an arithmetic average value of lengths, in the length direction (L-axis direction), of at least two negative electrode layer 165 among the negative electrode layers 165 which are disposed in plurality within the second margin region 235.

The lengths of the positive electrode layer 130, the negative electrode layer 150, the positive electrode margin layer 163, and the negative electrode margin layer 165 may refer to lengths in the length direction (L-axis direction), that is, lengths in the direction in which the first external electrode 300 disposed on the first surface S1 and the second external electrode 400 disposed on the second surface S2 face each other.

The active region 210 and the margin region may be formed so that the ratio ((a+c)/b) of the margin region length (a+c) to the active region length b is within a suitable range, considering the short circuit rate, discharge capacity, and energy density of the all-solid-state battery.

### Preparation Example: Manufacturing of All-Solid-State Battery

### Example 1

An all-solid-state battery with a length, a width, and a thickness of the battery main body of 10 mm, 10 mm, and 6 mm, respectively, and a ratio [margin region ratio ((a+c)/b)] of the positive electrode and negative electrode margin layer lengths a+c to the active region length b of 0.05 was manufactured.

### Example 2

An all-solid-state battery with a length, a width, and a thickness of the battery main body of 10 mm, 10 mm, and 6 mm, respectively, and a margin region ratio of 0.09 was manufactured.

### Example 3

An all-solid-state battery with a length, a width, and a thickness of the battery main body of 10 mm, 10 mm, and 6 mm, respectively, and a margin region ratio of 0.10 was manufactured.

### Comparative Example 1

An all-solid-state battery with a length, a width, and a thickness of the battery main body of 10 mm, 10 mm, and 6 mm, respectively, and a margin region ratio of 0.008 was manufactured.

### Comparative Example 2

An all-solid-state battery with a length, a width, and a thickness of the battery main body of 10 mm, 10 mm, and 6 mm, respectively, and a margin region ratio of 0.01 was manufactured.

### Comparative Example 3

An all-solid-state battery with a length, a width, and a thickness of the battery main body of 10 mm, 10 mm, and 6 mm, respectively, and a margin region ratio of 0.04 was manufactured.

### Comparative Example 4

An all-solid-state battery with a length, a width, and a thickness of the battery main body of 10 mm, 10 mm, and 6 mm, respectively, and a margin region ratio of 0.11 was manufactured.

### Comparative Example 5

An all-solid-state battery with a length, a width, and a thickness of the battery main body of 10 mm, 10 mm, and 6 mm, respectively, and a margin region ratio of 0.12 was manufactured.

### Comparative Example 6

An all-solid-state battery with a length, a width, and a thickness of the battery main body of 10 mm, 10 mm, and 6 mm, respectively, and a margin region ratio of 0.13 was manufactured.

### Comparative Example 7

An all-solid-state battery with a length, a width, and a thickness of the battery main body of 10 mm, 10 mm, and 6 mm, respectively, and a margin region ratio of 0.14 was manufactured.

### Comparative Example 8

An all-solid-state battery with a length, a width, and a thickness of the battery main body of 10 mm, 10 mm, and 6 mm, respectively, and a margin region ratio of 0.15 was manufactured.

### Comparative Example 9

An all-solid-state battery with a length, a width, and a thickness of the battery main body of 10 mm, 10 mm, and 6 mm, respectively, and a margin region ratio of 0.17 was manufactured.

### Comparative Example 10

An all-solid-state battery with a length, a width, and a thickness of the battery main body of 10 mm, 10 mm, and 6 mm, respectively, and a margin region ratio of 0.50 was manufactured.

### Experimental Example: Performance of All-Solid-State Battery

After manufacturing 50 all-solid-state batteries of each of Examples 1 to 5 and Comparison Examples 1 to 8, the short circuit, discharge capacity, and energy density were checked, and the results are summarized in Table 1.

TABLE 1

| | margin | | Average | Average | Average |
|---|---|---|---|---|---|
| | region | Short | discharge | energy | relative energy |
| | ratio | circuit | capacity | density | density_based |
| | (a + c)/b | rate(%) | (mAh) | (Wh/L) | on Example 1 |
| Comparative | 0.008 | 98 | 9.88 | 60.9 | 100.3 |
| Example 1 | | | | | |
| Comparative | 0.01 | 90 | 9.85 | 60.7 | 100 |
| Example 2 | | | | | |
| Comparative | 0.04 | 60 | 7.52 | 46.3 | 76.2 |
| Example 3 | | | | | |
| Example 1 | 0.05 | 24 | 7.43 | 45.8 | 75.4 |
| Example 2 | 0.09 | 16 | 6.92 | 42.6 | 70.1 |
| Example 3 | 0.10 | 16 | 6.88 | 42.4 | 70.0 |
| Comparative | 0.11 | 14 | 6.53 | 40.2 | 66.5 |
| Example 4 | | | | | |
| Comparative | 0.12 | 12 | 6.12 | 37.7 | 62.3 |
| Example 5 | | | | | |
| Comparative | 0.13 | 12 | 5.64 | 34.7 | 57.4 |
| Example 6 | | | | | |
| Comparative | 0.14 | 8 | 5.53 | 34.1 | 56.1 |
| Example 7 | | | | | |
| Comparative | 0.15 | 10 | 3.8 | 23.4 | 38.5 |
| Example 8 | | | | | |
| Comparative | 0.17 | 8 | 2.24 | 13.8 | 22.7 |
| Example 9 | | | | | |
| Comparative | 0.50 | 0 | 1.32 | 8.14 | 13.4 |
| Example 10 | | | | | |

Referring to Table 1, as shown in Comparative Example 1 to Comparative Example 3, the short circuit rate tended to drop significantly as the margin region ratio increased to 0.008, 0.01, and 0.04. However, it can be seen that when the margin region ratio is 0.04 or less, the short circuit rate is too high, exceeding 50%. As shown in Examples 1 to 3, when the margin region ratio is 0.05 or higher, the short circuit rate is relatively low at 24%. Furthermore, at the margin region ratios of 0.05 or more, the short circuit rate tends to decrease moderately even though the margin region ratio increases.

Investigating the decrease in the discharge capacity, the average discharge capacity was 6.92 mAh and 6.88 mAh for the all-solid-state battery with a margin region ratio of 0.09 (Example 2) and the all-solid-state battery with a margin region ratio of 0.10 (Example 3), respectively, and the decrease in the discharge capacity was not significant. On the other hand, the average discharge capacity of the all-solid-state battery with a margin region ratio of 0.10 (Example 3) and the all-solid-state battery with a margin region ratio of 0.11 (Comparative Example 4) was 6.88 mAh and 6.53 mAh, respectively, and the discharge capacity was decreased significantly. For the all-solid-state battery of Comparative Examples 4 to 10 with a margin region ratio exceeding 0.10, it was found that the decrease in discharge capacity generally became increasingly larger as the margin region ratio increased.

Investigating the decrease width in energy density, the all-solid-state battery with a margin region ratio of 0.09 (Example 4) and the all-solid-state battery with a margin region ratio of 0.10 (Example 5) did not show a significant decrease in energy density, with an average relative energy density of 70.1 and 70.0, respectively. On the other hand, the average relative energy density of the all-solid-state battery with a margin region ratio of 0.10 (Example 5) and the all-solid-state battery with a margin region ratio of 0.11 (Comparative Example 2) were 70.0 and 66.5, respectively, showing a significant decrease in the energy density decreased significantly as the margin region ratio increased.

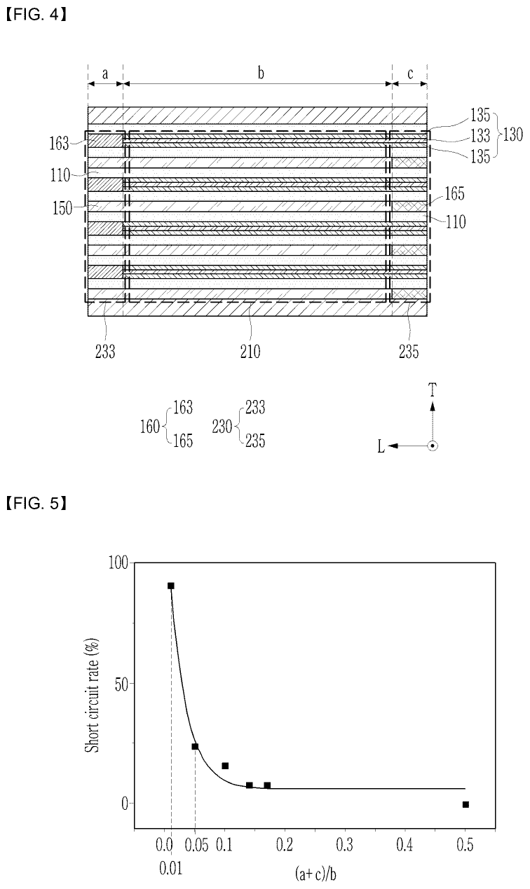

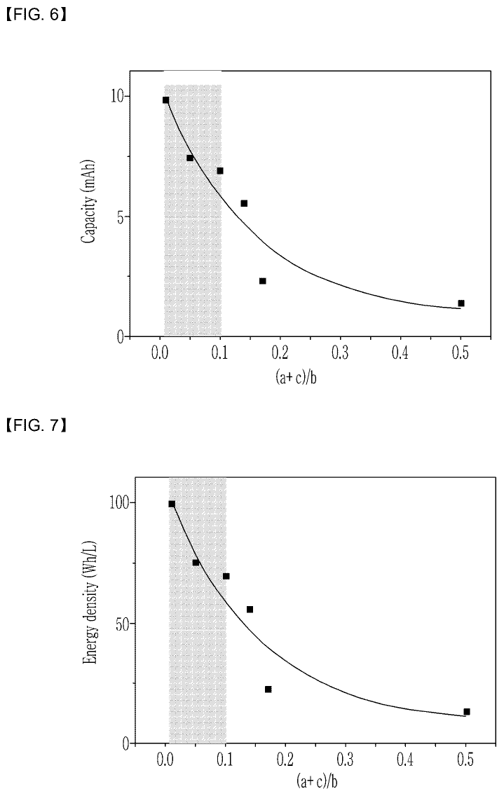

FIGS. 5 to 7 are graphs summarizing the above experimental examples, and FIG. 5 is a graph illustrating the relationship between a ratio of a margin region length to an active region length and a short circuit rate of the all-solid-state battery, FIG. 6 is a graph illustrating the relationship between a ratio of a margin region length to an active region length and a capacity of the all-solid-state battery, and FIG. 7 is a graph illustrating the relationship between a ratio of a margin region length to an active region length and an energy density of the all-solid-state battery.

Referring to FIG. 5, when the margin area ratio ((a+c)/b) is less than 0.05, the decrease width in the short circuit rate is large and the short circuit rate is very high, as the margin area ratio increases. When the margin region ratio is 0.05 or more, the short circuit rate is relatively low, and the decrease in the short circuit rate is also low as the margin region ratio increases is also low. There is a tradeoff between the short circuit rate and the capacity/energy density according to the increase/decrease of the margin region ratio. Therefore, it can be seen that even when the margin region ratio is reduced to increase the capacity/energy density, the margin region ratio needs to be 0.05 or more.

Referring to FIGS. 6 and 7, in the range where the margin region ratio ((a+c)/b) is 0.05 or more and 0.1 or less, the capacity and energy density tend to increase moderately. On the other hand, when the margin region ratio exceeds 0.1, the capacity and energy density tend to decrease significantly as the margin region ratio increases at least up to a certain range. Therefore, from the perspective of capacity/energy density, it can be seen that the margin region ratio needs to be 0.1 or less.

Although the embodiment of the present disclosure has been described, the present disclosure is not limited thereto, and it is possible to carry out various modifications within the scope of the claims, the detailed description of the invention, and the accompanying drawings, and the modifications belong to the scope of the present disclosure as a matter of course.

1. An all-solid-state battery comprising:
a solid electrolyte layer;
a first internal electrode layer and a second internal electrode layer opposite to each other with the solid electrolyte layer interposed therebetween;
a first external electrode connected with the first internal electrode layer;
a second external electrode connected with the second internal electrode layer;
a first margin layer disposed between the first internal electrode layer and the second external electrode; and
a second margin layer disposed between the second internal electrode layer and the first external electrode,
wherein an active region in which the first internal electrode layer and the second internal electrode layer overlap, the first margin layer, and the second margin layer satisfy 0.05≤(a+c)/b≤0.1, in which a is a length of the first margin layer, b is a length of the active region, and c is a length of the second margin layer.

2. The all-solid-state battery of claim 1, wherein:
the length of the active region, the length of the first margin layer, and the length of the second margin layer are lengths in a direction in which the first external electrode and the second external electrode face each other.

3. The all-solid-state battery of claim 1, wherein:
each of the first internal electrode layer and the second internal electrode layer is disposed in plurality, and
the length of the active region is a maximum value of lengths of overlapping portions of the plurality of the first internal electrode layers and the plurality of the second internal electrode layers.

4. The all-solid-state battery of claim 1, wherein:
each of the first internal electrode layer and the second internal electrode layer is disposed in plurality, and
the length of the active region is a minimum value of lengths of overlapping portions of the plurality of the first internal electrode layers and the plurality of the second internal electrode layers.

5. The all-solid-state battery of claim 1, wherein:
the first internal electrode layer and the second internal electrode layer are each disposed in a plurality, and
the length of the active region is an arithmetic average value of at least two lengths among lengths of at least two of overlapping portions of the plurality of the first internal electrode layers and the plurality of the second internal electrode layers.

6. The all-solid-state battery of claim 1, wherein:
each of the first margin layer and the second margin layer are each disposed in plurality,
the a is a maximum value of lengths of the plurality of the first margin layers, and
the c is a maximum value of lengths of the plurality of the second margin layers.

7. The all-solid-state battery of claim 1, wherein:
each of the first margin layer and the second margin layer is disposed in plurality,
the a is a minimum value of lengths of the plurality of the first margin layers, and
the c is a minimum value of lengths of the plurality of the second margin layers.

8. The all-solid-state battery of claim 1, wherein:
each of the first margin layer and the second margin layer is disposed in plurality,
the a is an arithmetic average value of lengths of at least two of the plurality of the first margin layers, and
the c is an arithmetic average value of lengths of at least two of the plurality of the second margin layers.

9. The all-solid-state battery of claim 1, wherein:
the first internal electrode layer is electrically connected to the first external electrode, and electrically isolated from the second external electrode by the first margin layer, and
the second internal electrode layer is electrically connected to the second external electrode, and electrically isolated from the first external electrode by the second margin layer.

10. The all-solid-state battery of claim 1, wherein:
the first and second margin layers include an insulating material.

11. The all-solid-state battery of claim 1, wherein:
the first and second margin layers include a ceramic material.

12. The all-solid-state battery of claim 11, wherein:
the ceramic material includes alumina (Al₂O₃), aluminum nitride (AlN), beryllium oxide (BeO), boron nitride (BN), silicon (Si), silicon carbide (SiC), silica (SiO₂), silicon nitride (Si₃N₄), gallium arsenide (GaAs), gallium nitride (GaN), barium titanate (BaTiO₃), zirconium dioxide (ZrO₂), or mixtures thereof.

13. The all-solid-state battery of claim 1, wherein:
the first margin layer and the second margin layer include a solid electrolyte included in the solid electrolyte layer.
